(19) United States
(12) Patent Application Publication
(10) Pub. No.: US 2016/0283118 A1
(43) Pub. Date: Sep. 29, 2016

(54) OPTIMIZATION OF DISK IMAGES FOR THIN PROVISIONED DISKS

(71) Applicant: International Business Machines Corporation, Armonk, NY (US)

(72) Inventors: Shrirang S. Bhagwat, Pune (IN); Janmejay S. Kulkarni, Navi Mumbai (IN); Sarvesh S. Patel, Nasik (IN); Subhojit Roy, Pune (IN)

(21) Appl. No.: 14/667,825

(22) Filed: Mar. 25, 2015

(51) Int. Cl. G06F 3/06

(52) U.S. Cl. CPC G06F 3/0604; G06F 3/0631; G06F 3/0644; G06F 3/0665; G06F 3/0673

(57) ABSTRACT

Embodiments of the present invention provide, systems, methods, and computer program products for optimizing disk images. Embodiments of the present invention generate sets of data that more efficiently describe unallocated regions of a virtual disk. Embodiments of the present invention can afford users to read a virtual disk and write data on the virtual disk as a disk image on local or remote storage components. Embodiments of the present invention can reduce network bandwidth required to create a disk image by reducing memory capacity needed to describe unallocated regions of the virtual disk.

### BACKGROUND OF THE INVENTION

The present invention relates generally to the field of virtual disks, and more particularly to a method of optimizing disk images for thin provisioned disks.

In a thin provisioned virtual disk, one or more portions of the logical address space presented to a host computer system are mapped to physical storage. The one or more portions are allocated by a storage controller when the first WRITE command to the region is received. Accordingly, the storage controller allocates physical storage for regions of the virtual disk that have allocated information. Thin provisioned virtual disks are implemented to save storage space by allocating storage space as required by an application instead of pre-allocating a large chunk of physical storage capacity that remains unused by the application.

### SUMMARY

Embodiments of the present invention provide systems, methods, and computer program products for optimizing disk images. In one embodiment, a method is provided, the method comprising: reading, by one or more computer processors, one or more portions of a virtual disk wherein the virtual disk includes, at least one or more unallocated regions; identifying, by one or more computer processors, the one or more unallocated regions of the virtual disk; generating, by one or more computer processors, a set of data describing the one or more unallocated regions of the virtual disk; and creating, by one or more computer processors, a disk image based, at least in part, on the set of data describing the one or more unallocated regions of the virtual disk.

### BRIEF DESCRIPTION OF THE DRAWINGS

FIG. 1 is a block diagram of a computing environment, in accordance with an embodiment of the present invention;

FIG. 2 is a flowchart illustrating operational steps for optimizing disk images for thin provisioned virtual disks, in accordance with an embodiment of the present invention; and

FIG. 3 is a block diagram of internal and external components of the computer systems of FIG. 1, in accordance with an embodiment of the present invention.

### DETAILED DESCRIPTION

Embodiments of the present invention provide systems, methods, and computer program products optimizing disk images for thin provisioned virtual disks. Embodiments of the present invention can reduce image creation time, size of the image, and storage space on a host computer system. Furthermore, embodiments of the present invention may be used to reduce bandwidth when transferring data from a storage controller to a host computer system.

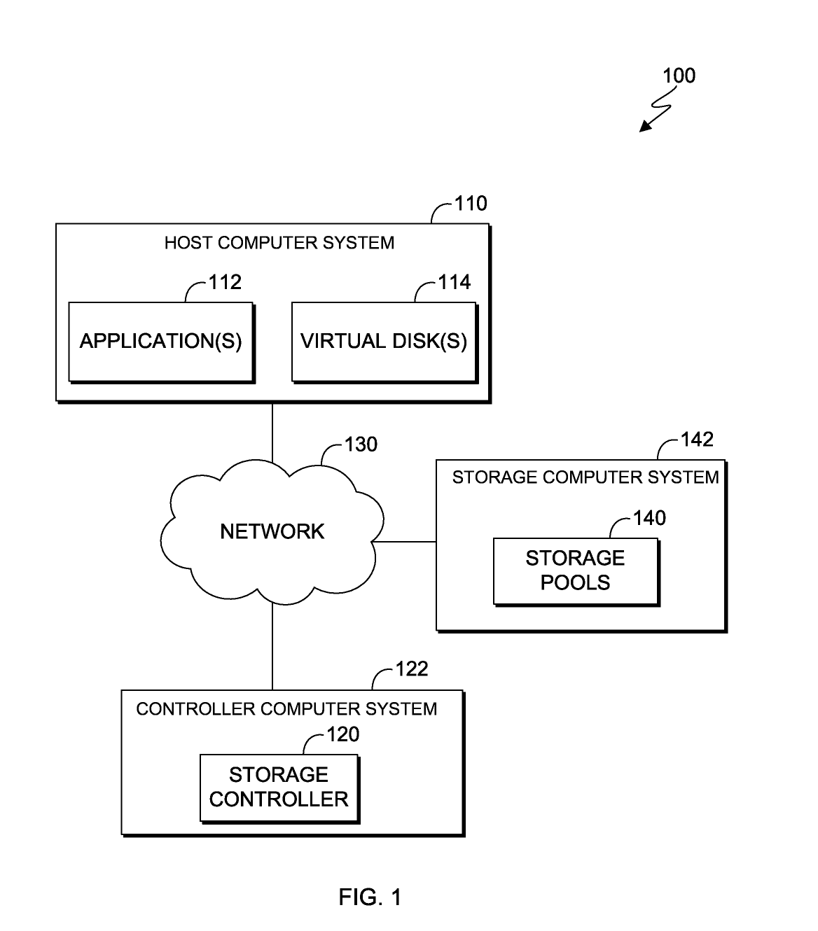

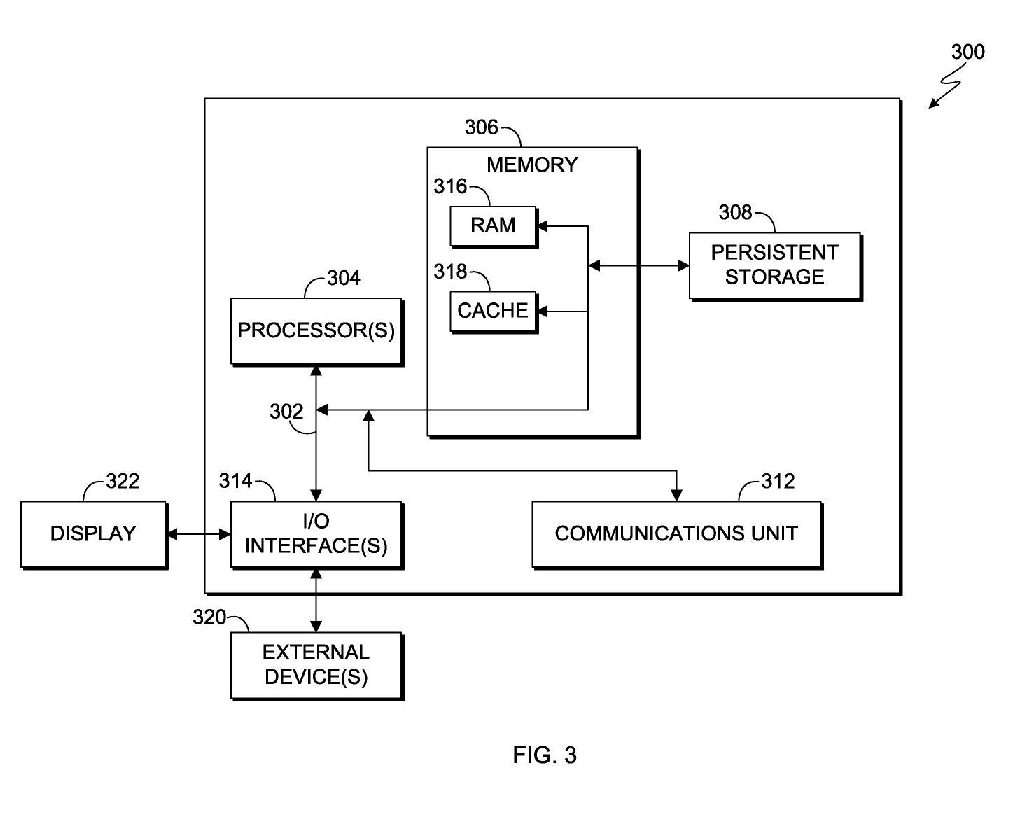

FIG. 1 is a block diagram of a computing environment 100, in accordance with an embodiment of the present invention. In one embodiment, computing environment 100 includes host computer system 110, controller computer system 122, and storage computer system 142, interconnected by network 130. Host computer system 110, controller computer system 122, and storage computer system 142 can be a desktop computers, laptop computers, specialized computer servers, or any other computer systems known in the art. In certain embodiments host computer system 110, controller computer system 122, and storage computer system 142 represent computer systems utilizing clustered computers and components to act as a single pool of seamless resources when accessed through network 130. For example, such embodiments may be used in data center, cloud computing, storage area network (SAN), and network attached storage (NAS) applications. In certain embodiments, host computer system 110 represent virtual machines. In general, host computer system 110, controller computer system 122, and storage computer system 142 are representative of any electronic device, or combination of electronic devices, capable of executing machine-readable program instructions, as discussed in greater detail with regard to FIG. 3.

Network 130 can be, for example, a local area network (LAN), a wide area network (WAN) such as the Internet, or a combination of the two, and include wired, wireless, or fiber optic connections. In general, network 130 can be any combination of connections and protocols that will support communications between host computer system 110, storage controller 120, and storage pools 140, in accordance with embodiments of the present invention.

Host computer system 110 includes one or more applications 112 and one or more virtual disks 114. In general, host computer system 110 may contain any number of applications 112 and/or virtual disks 114.

Applications 112 may be one or more programs or software configured to execute machine readable instructions. In this embodiment, applications 112 interact with virtual disks 114 and storage controller 120 to exchange information. For example, applications 112 may require information that is stored to virtual disks 114 and storage pools 140. In this instance, applications 112 interact with storage controller 120 to receive the information. In other embodiments, virtual disks 114 are disposed on a different computer system than applications 112. In this instance, information is exchanged via network 130.

Virtual disks 114 may be one or more files containing data for applications 112. In one embodiment, a file system (e.g., FAT, NTFS, ZFS, etc.) is implemented with virtual disks 114. In other embodiments, virtual disks 114 are raw virtual disks (i.e., unformatted virtual disks). In an embodiment, memory contained in virtual disks 114 are mapped to respective physical addresses stored in storage pools 140.

Controller computer system 122 includes storage controller 120. Storage controller 120 is a device that connects one or more components of computing environment 100 to a computer bus (i.e., a communication system that transfers data between one or more components of computing environment 100). In one embodiment, storage controller 120 is configured to operate alone (i.e., a single controller), in a redundant pair (i.e., a dual controller) as a node within a cluster of servers (scale out storage), or any other way known in the art. Storage controller 120 has an I/O path to communicate across a storage network (e.g., network 130) or directly-attached servers (not depicted).

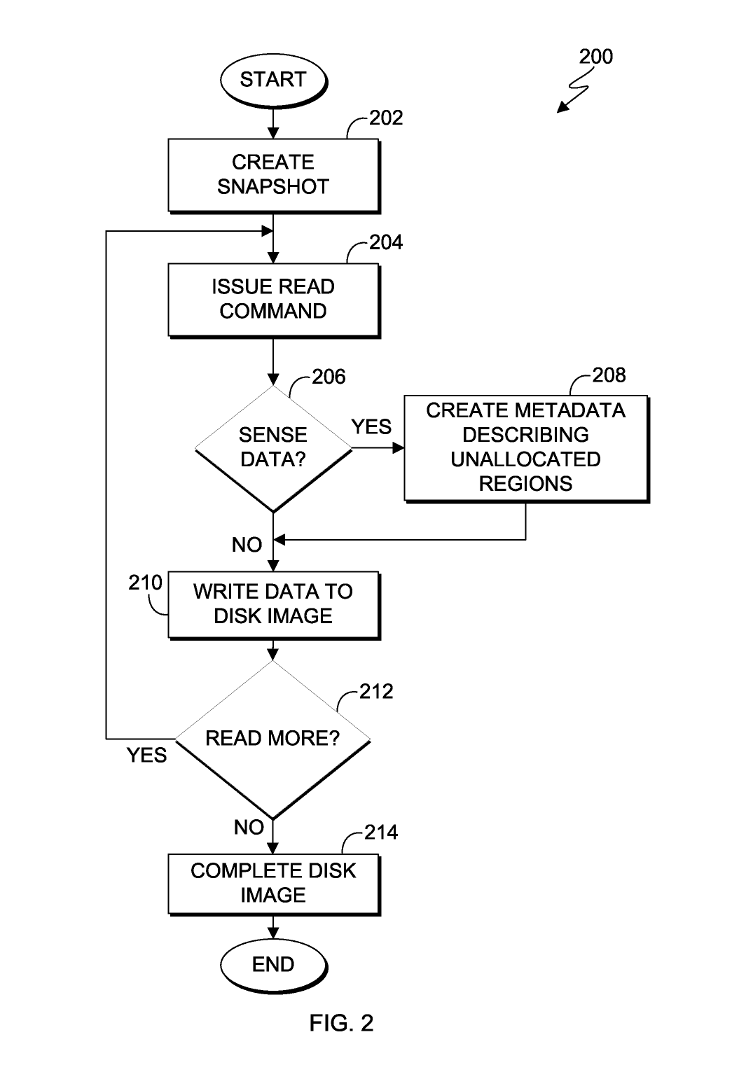

Storage computer system 142 includes storage pools 140. Storage pools 140 are storage capacity aggregated from one or more storage units in a shared storage environment. Storage pools 140 can be used in virtual computing environments by abstracting multiple physical storage disks into a logical construct with a specific capacity. In this embodiment, disk images are created on storage pools 140 from information stored on virtual disks 114, as described in greater detail in FIG. 2.

FIG. 2 is flowchart 200 illustrating operational steps for optimizing disk images for virtual disks 114, in accordance with an embodiment of the present invention. In one embodiment, storage controller 120 optimizes a READ command so that when the READ command returns, unallocated regions of virtual disks 114 are not returned as zeros. Storage controller 120 does not write any data for unallocated regions to storage pools 140, but instead describes the unallocated regions with a length and logical address, thus reducing the amount of data transmitted over network 130 for unallocated regions of virtual disks 114.

In step 202, storage controller 120 creates a snapshot of virtual disks 114 whose disk image must be created and determine the disk image's size. In one embodiment, storage controller 120 temporarily disables those I/O's whose image must be created and determines the image's size. In another embodiment, storage controller 120 quiesces (i.e., temporarily disables) input/output interfaces (e.g., FIG. 3, I/Os 314) to virtual disks 114.

In step 204, storage controller 120 issues READ commands. In one embodiment, storage controller 120 issues a small computer system interface (SCSI) READ command. In one embodiment, storage controller 120 issues the READ commands starting from logical block addressing (LBA) zero of virtual disks 114. In other embodiments, storage controller 120 issues a different READ command, implementing a different protocol that physically connects and transfers data between computer systems. The phrase, “logical block addressing”, as used herein, refers to a common scheme used for specifying locations of blocks of data stored on storage devices (e.g., virtual disks 114, storage pools 140, etc.). In other embodiments, storage controller 120 may issue READ commands starting from a user specified LBA of virtual disks 114.

In step 206, storage controller 120 determines whether SENSE DATA is returned. The phrase, “SENSE DATA”, as used herein, refers to a set of data indicating an offset and a length for one or more unallocated regions of virtual disk 114. In one embodiment, if SENSE DATA is returned for one or more regions of virtual disks 114 (i.e., blocks), the SENSE DATA contains information describing unallocated regions of the one or more portions of virtual disks 114.

If in step 206, storage controller 120 determines that SENSE DATA was not returned then in step 210, storage controller 120 writes data to a disk image stored on storage pools 140 or on a separate storage component, such as a separate storage component on host computer system 110 (not depicted). In one embodiment, once data for a SCSI READ command is returned and SENSE DATA is not returned, storage controller 120 issues a SCSI WRITE command to write the returned data from the SCSI READ command to storage pools 140 or on a separate storage component, such as a separate storage component on host computer system 110 (not depicted). In another embodiment, storage controller 120 may update the disk image stored on storage pools 140 or delete the disk image and create a new disk image. In certain embodiments, for each region written in storage pools 140 by storage controller 120, there is additional metadata indicating that the region contains application data. Furthermore, as discussed herein, metadata describing unallocated regions of memory in virtual disks 114 can be written on storage pools 140. As previously mentioned, in other embodiments, other READ and WRITE commands may be issued by storage controller 120 implementing a different protocol that physically connects and transfers data between computer systems.

If in step 206, storage controller 120 determines that SENSE DATA was returned, then in step 208, storage controller 120 creates metadata that contains information describing unallocated regions of virtual disks 114. In one embodiment, metadata can be created using SENSE DATA that describes the length of regions of unallocated memory. For example, “Unallocated Memory (LBA 1→LBA 5)” can be metadata that describes a specific region of virtual disks 114 that contain unallocated memory. Accordingly, as described in step 210, storage controller 120 writes data and metadata to a disk image stored on storage pools 140 or on a separate storage component on host computer system 110 (not depicted) to accurately describe unallocated regions of virtual disks 114.

In step 212, storage controller 120 determines whether additional READ commands need to be issued. In one embodiment, storage controller 120 determines that no additional READ commands are required when all designated regions of virtual disks 114 are written to storage pools 140. In another embodiment, storage controller 120 determines that additional READ commands are to be issued when one or more regions still need to be written to storage pools 140. As previously mentioned, in this embodiment, storage controller 120 determines whether additional SCSI READ commands are to be issued. In other embodiments, other READ commands may be issued by storage controller 120 that implement a different protocol which physically connects and transfers data between computer systems.

If, in step 212, storage controller 120 determines that additional READ commands need to be issued then, in step 204, storage controller 120 issues READ commands. In one embodiment, storage controller 120 issues SCSI READ commands. In other embodiments, other READ commands may be issued by storage controller 120 implementing a different protocol that physically connects and transfers data between one or more computer systems.

If, in step 212, storage controller 120 determines that no additional READ commands need to be issued then, in step 214, storage controller 120 creates the disk image by associating the image metadata with the image data. In one embodiment, image metadata is constructed by using an SCSI READ command with SENSE DATA, indicating that the region is unallocated and, therefore, consists of all ZEROs. In other embodiments, other READ commands may be issued by storage controller 120 implementing a different protocol that physically connects and transfers data between one or more computer systems. In certain embodiments, storage controller 120 issues WRITE commands to create the disk image on storage pools 140. In this instance, network bandwidth for network 130 is reduced for creating a disk image on storage pools 140 of virtual disks 114. Storage controller 120 can no longer use network 130 bandwidth to write ZEROS to the disk image for unallocated regions of virtual disks 114. Instead, storage controller 120 creates the disk image by issuing WRITE commands just for allocated regions of virtual disks 114 and uses SENSE DATA to describe the unallocated regions.

FIG. 3 is a block diagram of internal and external components of a computer system 300, which is representative the computer systems of FIG. 1, in accordance with an embodiment of the present invention. It should be appreciated that FIG. 3 provides only an illustration of one implementation and does not imply any limitations with regard to the environments in which different embodiments may be implemented. In general, the components illustrated in FIG. 3 are representative of any electronic device capable of executing machine-readable program instructions. Examples of computer systems, environments, and/or configurations that may be represented by the components illustrated in FIG. 3 include, but are not limited to, personal computer systems, server computer systems, thin clients, thick clients, laptop computer systems, tablet computer systems, cellular telephones (e.g., smart phones), multiprocessor systems, microprocessor-based systems, network PCs, minicomputer systems, mainframe computer systems, and distributed cloud computing environments that include any of the above systems or devices.

Computer system 300 includes communications fabric 302, which provides for communications between one or more processors 304, memory 306, persistent storage 308, communications unit 312, and one or more input/output (I/O) interfaces 314. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer-readable storage media. In one embodiment, memory 306 includes random access memory (RAM) 316 and cache memory 318. In general, memory 306 can include any suitable volatile or non-volatile computer-readable storage media. Software is stored in persistent storage 308 for execution and/or access by one or more of the respective processors 304 via one or more memories of memory 306.

Persistent storage 308 may include, for example, a plurality of magnetic hard disk drives. Alternatively, or in addition to magnetic hard disk drives, persistent storage 308 can include one or more solid state hard drives, semiconductor storage devices, read-only memories (ROM), erasable programmable read-only memories (EPROM), flash memories, or any other computer-readable storage media that is capable of storing program instructions or digital information.

The media used by persistent storage 308 can also be removable. For example, a removable hard drive can be used for persistent storage 308. Other examples include optical and magnetic disks, thumb drives, and smart cards that are inserted into a drive for transfer onto another computer-readable storage medium that is also part of persistent storage 308.

Communications unit 312 provides for communications with other computer systems or devices via a network (e.g., network 130). In this exemplary embodiment, communications unit 312 includes network adapters or interfaces such as a TCP/IP adapter cards, wireless Wi-Fi interface cards, or 3G or 4G wireless interface cards or other wired or wireless communication links. The network can comprise, for example, copper wires, optical fibers, wireless transmission, routers, firewalls, switches, gateway computers and/or edge servers. Software and data used to practice embodiments of the present invention can be downloaded through communications unit 312 (e.g., via the Internet, a local area network or other wide area network). From communications unit 312, the software and data can be loaded onto persistent storage 308.

One or more I/O interfaces 314 allow for input and output of data with other devices that may be connected to computer system 300. For example, I/O interface 314 can provide a connection to one or more external devices 320 such as a keyboard, computer mouse, touch screen, virtual keyboard, touch pad, pointing device, or other human interface devices. External devices 320 can also include portable computer-readable storage media such as, for example, thumb drives, portable optical or magnetic disks, and memory cards. I/O interface 314 also connects to display 322.

Display 322 provides a mechanism to display data to a user and can be, for example, a computer monitor. Display 322 can also be an incorporated display and may function as a touch screen, such as a built-in display of a tablet computer.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for optimizing disk images, the method comprising:
reading, by one or more computer processors, one or more portions of a virtual disk wherein the virtual disk includes, at least, one or more unallocated regions;
identifying, by one or more computer processors, the one or more unallocated regions of the virtual disk;
generating, by one or more computer processors, a set of data describing the one or more unallocated regions of the virtual disk; and
creating, by one or more computer processors, a disk image based, at least in part on, the set of data describing the one or more unallocated regions of the virtual disk.

2. The method of claim 1, further comprising:
issuing, by one or more computer processors, a read command to read the one or more portions of the virtual disk, wherein the read command is configured to return the set of data describing the one or more unallocated regions of the virtual disk.

3. The method of claim 1, wherein the set of data describing the one or more unallocated regions of the virtual disk includes, at least, a length and an offset for each region of the one or more unallocated regions of the virtual disk.

4. The method of claim 1, wherein the set of data describing the one or more unallocated regions of the virtual disk is of a smaller data size than one or more zeros that describe the one or more unallocated regions of the virtual disk.

5. The method of claim 1, wherein creating the disk image based, at least in part, on the set of data describing the one or more unallocated regions of the virtual disk comprise:
writing, by one or more computer processors, allocated regions of the virtual disk to the disk image; and
writing, by one or more computer processors, the set of data describing the one or more unallocated regions of the virtual disk.

6. The method of claim 2, wherein issuing the READ command to read the one or more portions of the virtual disk, wherein the READ command is configured to return the set of data describing the one or more unallocated regions of the virtual disk comprise:
reading, by one or more computer processors, the virtual disk sequentially from logical block address zero, wherein logical block address zero is the first block of data stored the virtual disk.

7. The method of claim 3, wherein the length is a number of unallocated blocks of the virtual disk; and
wherein the offset is a location in which the length begins within the virtual disk.

8. A computer program product for optimizing disk images, comprising:
one or more computer readable storage media and program instructions stored on the one or more computer readable storage media, the program instructions comprising:
program instructions to read one or more portions of a virtual disk, wherein the virtual disk includes, at least, one or more unallocated regions;
program instructions to identify the one or more unallocated regions of the virtual disk;
program instructions to generate a set of data describing the one or more unallocated regions of the virtual disk; and
program instructions to create a disk image based, at least in part, on the set of data describing the one or more unallocated regions of the virtual disk.

9. The computer program product of claim 8, further comprising:
program instructions, stored on the one or more computer readable storage media, to issue a read command to read the one or more portions of the virtual disk, wherein the read command is configured to return the set of data describing the one or more unallocated regions of the virtual disk.

10. The computer program product of claim 8, wherein the set of data describing the one or more unallocated regions of the virtual disk includes, at least, a length and an offset for each region of the one or more unallocated regions of the virtual disk.

11. The computer program product of claim 8, wherein the set of data describing the one or more unallocated regions of the virtual disk is of a smaller data size than one or more zeros that describe the one or more unallocated regions of the virtual disk.

12. The computer program product of claim 8, wherein program instructions to create the disk image based, at least in part, on the set of data describing the one or more unallocated regions of the virtual disk comprise:
program instructions to write allocated regions of the virtual disk to the disk image; and
program instructions to write the set of data describing the one or more unallocated regions of the virtual disk.

13. The computer program product of claim 9, wherein program instructions to issue the READ command to read the one or more portions of the virtual disk, wherein the READ command is configured to return the set of data describing the one or more unallocated regions of the virtual disk comprise:
program instructions to read the virtual disk sequentially from logical block address zero, wherein logical block address zero is the first block of data stored the virtual disk.

14. The computer program product of claim 10, wherein the length is a number of unallocated blocks of the virtual disk; and
wherein the offset is a location in which the length begins within the virtual disk.

15. A computer system for optimizing disk images, comprising:
one or more computer processors, one or more computer readable storage media, and program instructions stored on the one or more computer readable storage media for execution by at least one of the one or more processors, the program instructions comprising:
program instructions to read one or more portions of a virtual disk, wherein the virtual disk includes, at least, one or more unallocated regions;
program instructions to identify the one or more unallocated regions of the virtual disk;
program instructions to generate a set of data describing the one or more unallocated regions of the virtual disk; and
program instructions to create a disk image based, at least in part, on the set of data describing the one or more unallocated regions of the virtual disk.

16. The computer system of claim 15, further comprising:
program instructions, stored on the one or more computer readable storage media for execution by at least one of the one or more processors, to issue a READ command to read the one or more portions of the virtual disk, wherein the READ command is configured to return the set of data describing the one or more unallocated regions of the virtual disk.

17. The computer system of claim 15, wherein the set of data describing the one or more unallocated regions of the virtual disk includes, at least, a length and an offset for each region of the one or more unallocated regions of the virtual disk.

18. The computer system of claim 15, wherein the set of data describing the one or more unallocated regions of the virtual disk is of a smaller data size than one or more zeros that describe the one or more unallocated regions of the virtual disk.

19. The computer system of claim 15, wherein program instructions to create the disk image based, at least in part, on the set of data describing the one or more unallocated regions of the virtual disk comprise:
program instructions to write allocated regions of the virtual disk to the disk image; and
program instructions to write the set of data describing the one or more unallocated regions of the virtual disk.

20. The computer system of claim 16, wherein program instructions to issue the READ command to read the one or more portions of the virtual disk, wherein the READ command is configured to return the set of data describing the one or more unallocated regions of the virtual disk comprise:
program instructions to read the virtual disk sequentially from logical block address zero, wherein logical block address zero is the first block of data stored the virtual disk.
